(19) United States
(12) Patent Application Publication
(10) Pub. No.: US 2024/0256736 A1
(43) Pub. Date: Aug. 1, 2024

(54) METHOD OF MEASURING AMOUNT OF AUTOMOTIVE BODY DEFORMATION AND PROGRAM OF MEASURING AMOUNT OF AUTOMOTIVE BODY DEFORMATION IN CRASHWORTHINESS ANALYSIS OF AUTOMOBILE

(71) Applicant: JFE STEEL CORPORATION, Tokyo (JP)

(72) Inventor: Takanobu SAITO, Tokyo (JP)

(73) Assignee: JFE STEEL CORPORATION, Tokyo (JP)

(21) Appl. No.: 18/289,454

(22) PCT Filed: Mar. 15, 2022
(86) PCT No.: PCT/JP2022/011519

§ 371 Date: Nov. 3, 2023

(30) Foreign Application Priority Data
May 10, 2021 (JP) 2021-079492

(51) Int. Cl. G06F 30/20; G06F 30/15; G06F 119/14

(52) U.S. Cl. CPC G06F 30/20; G06F 30/15; G06F 2119/14

(57) ABSTRACT

A method of measuring an amount of automotive body deformation in a crashworthiness analysis includes: acquiring a crashworthiness analysis model of an automobile deformed by impact; performing the crashworthiness analysis of the crashworthiness analysis model; setting a measurement point where the amount of automotive body deformation in the crashworthiness analysis model is measured; setting three reference points in a portion with no or little deformation of the automotive body in the crashworthiness analysis model; acquiring coordinates of the measurement point and coordinates of the three reference points at the start of the impact; acquiring the coordinates of the measurement point and the coordinates of the three reference points after the impact; and measuring the amount of the automotive body deformation at the measurement point by using the coordinates of the measurement point before the automotive body deformation and the coordinates of the measurement point after the impact.

### FIELD

The present invention relates to a method of measuring an amount of automotive body deformation and a program of measuring an amount of automotive body deformation in a crashworthiness analysis of an automobile.

### BACKGROUND

In recent years, weight reduction of an automotive body, which is caused by an environmental problem has been advanced specifically in an automotive industry, and a computer aided engineering analysis (CAE analysis) has become an essential technique for automotive body design. In this CAE analysis, a rigidity analysis, a crashworthiness analysis, a vibration analysis, and the like are performed, which greatly contribute to improvement in automotive body performance.

In order to improve crash worthiness by the CAE analysis, for example, Non Patent Literature 1 discloses a technique of acquiring a plastic deformation property of a rudder frame at the time of a frontal impact of a pickup truck by a crash simulation.

### CITATION LIST

### Non Patent Literature

Non Patent Literature 1: Arita et al., “Improvement of Accuracy for Crash Worthiness Simulation of Frame of Pickup Truck”, Transactions of Society of Automotive Engineers of Japan, Vol. 46, No. 6, November 2015.

### SUMMARY

### Technical Problem

However, the technique disclosed in Non Patent Literature 1 is a crashworthiness analysis in which only a rudder frame that is an automotive body part of an automobile is a target of the analysis, and does not target the entire automobile. Thus, it is difficult to completely reproduce automotive body deformation at the time of a crash of the automobile.

In addition, as illustrated in FIG. 10, even when side impact analysis with an impactor 11 is performed by utilization of a crashworthiness analysis model 1 in which the entire automobile is to be analyzed, the entire crashworthiness analysis model 1 makes parallel movement and rotational movement in addition to deformation of an automotive body 3. Thus, as illustrated in FIG. 10(c), in addition to an amount of automotive body deformation of the automotive body 3 due to impact, displacement due to the parallel movement or the rotational movement of the entire crashworthiness analysis model 1 may be generated. Thus, in order to evaluate the amount of automotive body deformation by the crashworthiness analysis using the crashworthiness analysis model 1 that models the entire automobile, a technique of removing a movement amount due to the parallel movement or the rotational movement of the crashworthiness analysis model 1 has been desired.

The present invention has been made in view of the above problems, and an object thereof is to provide, in a crashworthiness analysis using a crashworthiness analysis model of an automobile, a method of measuring an amount of automotive body deformation and a program of measuring the amount of automotive body deformation in the crashworthiness analysis of the automobile, the method and program being capable of measuring an amount of automotive body deformation from which a movement amount due to a parallel movement or a rotational movement caused by impact on a crashworthiness analysis model is removed.

### Solution to Problem

As a result of intensive studies on the problem described above, the inventor has focused on a fact that “there is a portion that is not deformed or is extremely hardly deformed by impact”. Then, the inventors have conceived to measure an amount of automotive body deformation by removing a parallel movement amount and a rotational movement amount of an automobile due to the impact by using the portion. The present invention has been made based on the above studies, and specifically has the following configuration.

A method of measuring an amount of automotive body deformation in a crashworthiness analysis of an automobile deformed by impact in a crashworthiness analysis according to a first aspect of the present invention is executed by a computer and includes: a crashworthiness analysis model acquisition step of acquiring a crashworthiness analysis model of the automobile; a crashworthiness analysis step of performing the crashworthiness analysis of the crashworthiness analysis model; a step of setting a measurement point of the amount of automotive body deformation and reference points in which step the measurement point at which the amount of automotive body deformation in the crashworthiness analysis model is measured and three reference points in a portion with no or little deformation of the automotive body in the crashworthiness analysis model are set; a step of acquiring measurement point coordinates and reference point coordinates at a start of the impact in which step coordinates of the measurement point and coordinates of the three reference points in the crashworthiness analysis model at the start of the impact are acquired; a step of acquiring the measurement point coordinates and the reference point coordinates after the impact in which step the coordinates of the measurement point and the coordinates of the three reference points after the impact are acquired for the crashworthiness analysis model after the impact after a lapse of a predetermined time from the start of the impact based on a result of the crashworthiness analysis; a step of calculating a reference point-measurement point distance at the start of the impact in which step a distance to the measurement point at the start of the impact is calculated for each of the three reference points by utilization of the coordinates of the measurement point and the coordinates of the three reference points in the crashworthiness analysis model at the start of the impact; a step of acquiring the measurement point coordinates before the automotive body deformation in which step coordinates of a position that satisfies a same distance relationship as the distance from each of the three reference points at the start of the impact in the crashworthiness analysis model after the impact are acquired as the coordinates of the measurement point before the automotive body deformation in the crashworthiness analysis model after the impact; and a step of measuring the amount of automotive body deformation in which step the amount of the automotive body deformation at the measurement point is measured by utilization of the coordinates of the measurement point before the automotive body deformation, which coordinates are acquired for the crashworthiness analysis model after the impact, and the coordinates of the measurement point after the impact.

A method of measuring an amount of automotive body deformation in a crashworthiness analysis of an automobile deformed by impact in a crashworthiness analysis according to a second aspect of the present invention is executed by a computer and includes: a crashworthiness analysis model acquisition step of acquiring a crashworthiness analysis model of the automobile; a crashworthiness analysis step of performing the crashworthiness analysis of the crashworthiness analysis model; a step of setting a measurement point of the amount of automotive body deformation and reference points in which step the measurement point at which the amount of automotive body deformation in the crashworthiness analysis model is measured and three reference points in a portion with no or little deformation of the automotive body in the crashworthiness analysis model are set; a step of acquiring measurement point coordinates and reference point coordinates at a start of the impact in which step coordinates of the measurement point and coordinates of the three reference points in the crashworthiness analysis model at the start of the impact are acquired; a step of acquiring the measurement point coordinates and the reference point coordinates after the impact in which step the coordinates of the measurement point and the coordinates of the three reference points after the impact are acquired for the crashworthiness analysis model after the impact after a lapse of a predetermined time from the start of the impact based on a result of the crashworthiness analysis; a step of calculating a reference point-measurement point distance after the impact in which step a post-impact distance to the measurement point is calculated for each of the three reference points by utilization of the coordinates of the measurement point and the coordinates of the three reference points in the crashworthiness analysis model after the impact; a step of acquiring the measurement point coordinates after the automotive body deformation in which step coordinates of a position that satisfies a same distance relationship as the post-impact distance from each of the three reference points in the crashworthiness analysis model at the start of the impact are acquired as the coordinates of the measurement point after the automotive body deformation by the impact in the crashworthiness analysis model at the start of the impact; and a step of measuring the amount of automotive body deformation in which step the amount of automotive body deformation at the measurement point is measured by utilization of the coordinates of the measurement point after the automotive body deformation, which coordinates are acquired for the crashworthiness analysis model at the start of the impact, and the coordinates of the measurement point at the start of the impact.

A program for causing a computer to measure an amount of automotive body deformation of an automobile deformed by impact in a crashworthiness analysis according to the first aspect of the present invention causes the computer to execute: a crashworthiness analysis model acquisition step of acquiring a crashworthiness analysis model of the automobile; a crashworthiness analysis step of performing the crashworthiness analysis of the crashworthiness analysis model; a step of setting a measurement point of the amount of automotive body deformation and reference points in which step the measurement point at which the amount of automotive body deformation in the crashworthiness analysis model is measured and three reference points in a portion with no or little deformation of the automotive body in the crashworthiness analysis model are set; a step of acquiring measurement point coordinates and reference point coordinates at a start of the impact in which step coordinates of the measurement point and coordinates of the three reference points in the crashworthiness analysis model at the start of the impact are acquired; a step of acquiring the measurement point coordinates and the reference point coordinates after the impact in which step the coordinates of the measurement point and the coordinates of the three reference points after the impact are acquired for the crashworthiness analysis model after the impact after a lapse of a predetermined time from the start of the impact based on a result of the crashworthiness analysis; a step of calculating a reference point-measurement point distance at the start of the impact in which step a distance to the measurement point at the start of the impact is calculated for each of the three reference points by utilization of the coordinates of the measurement point and the coordinates of the three reference points in the crashworthiness analysis model at the start of the impact; a step of acquiring the measurement point coordinates before the automotive body deformation in which step coordinates of a position that satisfies a same distance relationship as the distance from each of the three reference points at the start of the impact in the crashworthiness analysis model after the impact are acquired as the coordinates of the measurement point before the automotive body deformation in the crashworthiness analysis model after the impact; and a step of measuring the amount of automotive body deformation in which step the amount of the automotive body deformation at the measurement point is measured by utilization of the coordinates of the measurement point before the automotive body deformation, which coordinates are acquired for the crashworthiness analysis model after the impact, and the coordinates of the measurement point after the impact.

A program for causing a computer to measure an amount of automotive body deformation of an automobile deformed by impact in a crashworthiness analysis according to the second aspect of the present invention causes the computer to execute: a crashworthiness analysis model acquisition step of acquiring a crashworthiness analysis model of the automobile; a crashworthiness analysis step of performing the crashworthiness analysis of the crashworthiness analysis model; a step of setting a measurement point of the amount of automotive body deformation and reference points in which step the measurement point at which the amount of automotive body deformation in the crashworthiness analysis model is measured and three reference points in a portion with no or little deformation of the automotive body in the crashworthiness analysis model are set; a step of acquiring measurement point coordinates and reference point coordinates at a start of the impact in which step coordinates of the measurement point and coordinates of the three reference points in the crashworthiness analysis model at the start of the impact are acquired; a step of acquiring the measurement point coordinates and the reference point coordinates after the impact in which step the coordinates of the measurement point and the coordinates of the three reference points after the impact are acquired for the crashworthiness analysis model after the impact after a lapse of a predetermined time from the start of the impact based on a result of the crashworthiness analysis; a step of calculating a reference point-measurement point distance after the impact in which step a post-impact distance to the measurement point is calculated for each of the three reference points by utilization of the coordinates of the measurement point and the coordinates of the three reference points in the crashworthiness analysis model after the impact; a step of acquiring the measurement point coordinates after the automotive body deformation in which step coordinates of a position that satisfies a same distance relationship as the post-impact distance from each of the three reference points in the crashworthiness analysis model at the start of the impact are acquired as the coordinates of the measurement point after the automotive body deformation by the impact in the crashworthiness analysis model at the start of the impact; and a step of measuring the amount of automotive body deformation in which step the amount of automotive body deformation at the measurement point is measured by utilization of the coordinates of the measurement point after the automotive body deformation, which coordinates are acquired for the crashworthiness analysis model at the start of the impact, and the coordinates of the measurement point at the start of the impact.

### Advantageous Effects of Invention

According to the present invention, it is possible to remove a parallel movement amount and a rotational movement amount of the entire automotive body due to impact and to measure an amount of automotive body deformation at a measurement point at which the amount of automotive body deformation is measured. As a result, since the amount of automotive body deformation due to the impact can be accurately acquired, an automotive body deformation phenomenon due to the impact can be understood, and improvement in the crash worthiness and weight reduction of the automobile become possible.

### BRIEF DESCRIPTION OF DRAWINGS

FIG. 1 is a flowchart illustrating a flow in a method of measuring an amount of automotive body deformation in a crashworthiness analysis of an automobile according to a first embodiment of the present invention.

FIG. 2 is a view for describing a crashworthiness analysis of a crashworthiness analysis model targeted in the first embodiment, a second embodiment, and an example of the present invention.

FIG. 3 is a view illustrating measurement points set on a floor panel of the crashworthiness analysis model in the first and second embodiments and the example.

FIG. 4 is a view for describing reference points set in the crashworthiness analysis model in the first embodiment, the second embodiment, and the example.

FIG. 5 is a view for describing a procedure of acquiring an amount of automotive body deformation in the first embodiment.

FIG. 6 is a view for describing an example of acquiring a position that satisfies the same distance relationship as a distance at a start of impact between a measurement point and three reference points at the start of the impact in the crashworthiness analysis model after the impact in the first embodiment, ((a) three spherical surfaces centered on the three reference points, and (b) intersection points of the three spherical surfaces).

FIG. 7 is a flowchart illustrating a flow of processing in a method of measuring an amount of automotive body deformation in crashworthiness analysis of an automobile according to the second embodiment.

FIG. 8 is a view for describing a procedure of acquiring the amount of automotive body deformation in the second embodiment.

FIG. 9 is a view for describing an example of acquiring a position that satisfies the same distance relationship as a post-impact distance between a measurement point and three reference points after impact in the crashworthiness analysis model at a start of the impact in the second embodiment ((a) three spherical surfaces centered on three reference points, and (b) intersection points of the three spherical surfaces).

FIG. 10 is a view for describing a problem in the crashworthiness analysis using the crashworthiness analysis model.

### DESCRIPTION OF EMBODIMENTS

Before describing methods of measuring an amount of automotive body deformation and programs of measuring the amount of automotive body deformation in a crashworthiness analysis of an automobile according to the first embodiment and the second embodiment of the present invention, a crashworthiness analysis model to be analyzed in the crashworthiness analysis in the first embodiment and the second embodiment will be described.

### <Crashworthiness Analysis Model>

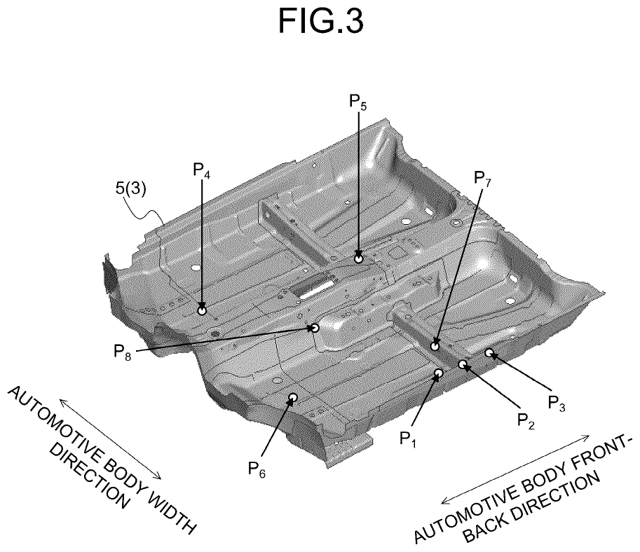

As illustrated in FIG. 2 as an example, a crashworthiness analysis model 1 targeted in the first embodiment and the second embodiment includes an automotive body 3 modeled by an element (shell element and/or solid element) and a node. The automotive body 3 includes a plurality of automotive body parts such as a floor panel 5 (FIG. 3) modeled by the element and the node.

### First Embodiment

Next, a method of measuring an amount of automotive body deformation and a program of measuring the amount of automotive body deformation in a crashworthiness analysis of an automobile according to the first embodiment of the present invention will be described in the following.

### <Method of Measuring an Amount of Automotive Body Deformation>

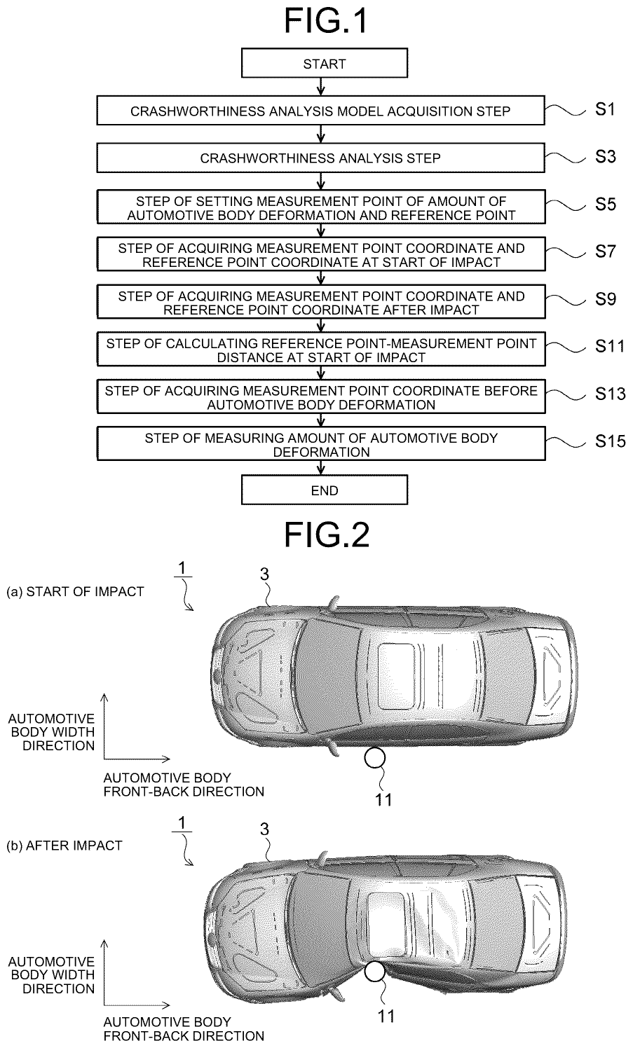

The method of measuring an amount of automotive body deformation in the crashworthiness analysis of the automobile according to the first embodiment (hereinafter, referred to as the “method of measuring the amount of automotive body deformation”) is to measure the amount of automotive body deformation of the automobile deformed by the impact in the crashworthiness analysis of the automobile, and includes, as illustrated in FIG. 1, a crashworthiness analysis model acquisition step S1, a crashworthiness analysis step S3, a step of setting a measurement point of an amount of automotive body deformation and a reference point S5, a step of acquiring measurement point coordinates and reference point coordinates at a start of impact S7, a step of acquiring measurement point coordinates and reference point coordinates after the impact S9, a step of calculating a reference point-measurement point distance at the start of the impact S11, a step of acquiring measurement point coordinates before the automotive body deformation S13, and a step of measuring the amount of automotive body deformation S15, the steps being performed by a computer. Each of the above steps will be described below.

### <<Crashworthiness Analysis Model Acquisition Step>>

The crashworthiness analysis model acquisition step S1 is to acquire a crashworthiness analysis model of an automobile. In the first embodiment, as described above, a crashworthiness analysis model illustrated in FIG. 2(a) as an example is acquired.

### <<Crashworthiness Analysis Step>>

The crashworthiness analysis step S3 is to perform a crashworthiness analysis of the crashworthiness analysis model acquired in the crashworthiness analysis model acquisition step S1.

In the first embodiment, as illustrated as the example in FIG. 2, the crashworthiness analysis in which an impactor 11 performs side impact on a left side surface of the crashworthiness analysis model 1 in an automotive body width direction is performed in the crashworthiness analysis step S3. Thus, in the crashworthiness analysis, crashworthiness analysis conditions such as a position, a direction, and an impact speed at which the impactor 11 makes the Impact are Appropriately Set.

### <<Step of Setting a Measurement Point of an Amount of Automotive Body Deformation and a Reference Point>>

The step of setting a measurement point of the amount of automotive body deformation and a reference point S5 is to set a measurement point at which the amount of automotive body deformation in the crashworthiness analysis model is measured, and three reference points at a portion where the deformation of the automotive body is small.

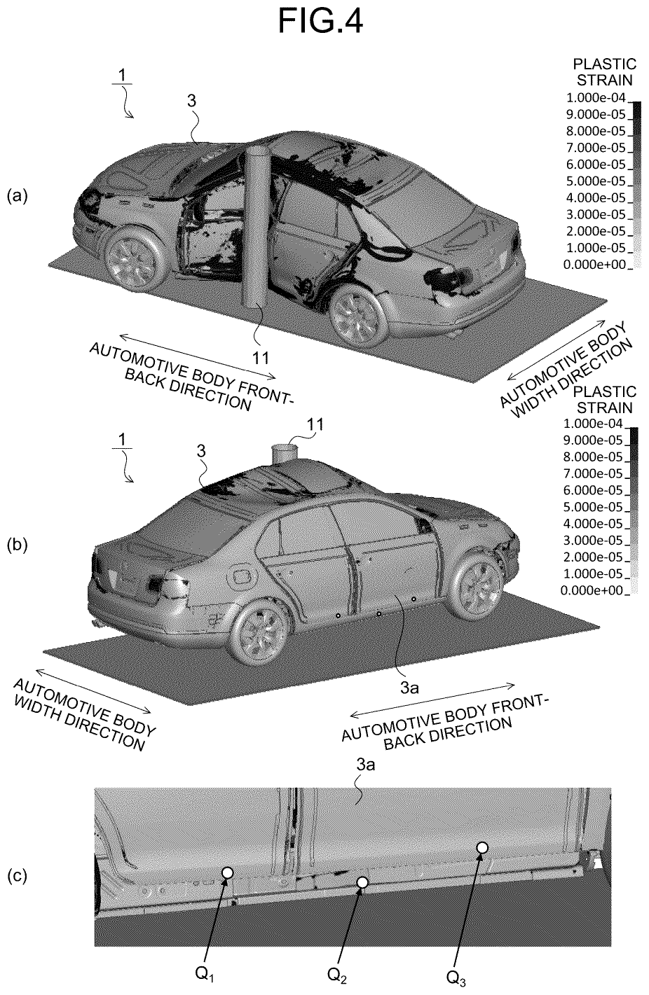

In the first embodiment, in the step of setting the measurement point of the amount of automotive body deformation and the reference point S5, as illustrated in FIG. 3, the measurement points P₁ to P₈ are set on the floor panel 5 included in a part of the automotive body 3 of the crashworthiness analysis model 1. Furthermore, in the step of setting the measurement point of the amount of automotive body deformation and the reference point S5, as illustrated in FIG. 4(c), three reference points Q₁ to Q₃ are set on a right side surface portion 3a of the crashworthiness analysis model 1.

The portion in which there is no or little deformation of the automotive body and in which the three reference points are set in the crashworthiness analysis model may be, for example, a portion where there is no or little strain in the crashworthiness analysis model based on the result of the crashworthiness analysis in the crashworthiness analysis step S3. In the first embodiment, as illustrated in FIG. 2 described above, the crashworthiness analysis in which the impactor 11 is made to perform side impact on the left side surface of the crashworthiness analysis model 1 is the target. Thus, as illustrated in FIGS. 4(a) and (b), the three reference points Q₁ to Q₃ are set on the right side surface portion 3a where the strain of the automotive body deformation of the crashworthiness analysis model 1 is sufficiently small. Note that as a guide of a value of the strain of when the reference points are set, the strain is made to be 1% or smaller.

In addition, since coordinates of the node of the crashworthiness analysis model are calculated in the crashworthiness analysis in the crashworthiness analysis step S3, the measurement point and the three reference points may be set at the position of the node in the crashworthiness analysis model in the step of setting the measurement point of the amount of automotive body deformation and the reference point S5.

Furthermore, the step of setting the measurement point of the amount of automotive body deformation and the reference point S5 may be executed before the crashworthiness analysis step S3.

### <<Step of Acquiring Measurement Point Coordinates and Reference Point Coordinates at a Start of Impact>>

The step of acquiring measurement point coordinates and reference point coordinates at the start of the impact S7 is to acquire coordinates of the measurement point and coordinates of the three reference points in the crashworthiness analysis model at the start of the impact.

In the first embodiment, the coordinates at the start of the impact of the measurement points P₁ to P₈ set on the floor panel 5 of the crashworthiness analysis model 1 (FIG. 3) and the coordinates at the start of the impact of the reference points Q₁ to Q₃ set on the right side surface portion 3a of the crashworthiness analysis model 1 (FIG. 4(c)) are acquired.

Note that in a case where nodes of the crashworthiness analysis model are set as the measurement point and the three reference points in the step of setting the measurement point of the amount of automotive body deformation and the reference point S5, the coordinates of each of the set nodes may be acquired.

Furthermore, the step of acquiring measurement point coordinates and reference point coordinates at the start of the impact S7 may be executed before the crashworthiness analysis step S3.

<<Step of Acquiring Measurement Point Coordinates and Reference Point Coordinates after Impact>>

The step of acquiring measurement point coordinates and reference point coordinates after the impact S9 is to acquire the coordinates of the measurement point and the coordinates of the three reference points after the impact with respect to the crashworthiness analysis model after the impact after a lapse of a predetermined time from the start of the impact based on the result of the crashworthiness analysis in the crashworthiness analysis step S3.

In the first embodiment, the coordinates of the measurement points P₁ to P₈ and the coordinates of the reference points Q₁ to Q₃ in the crashworthiness analysis model 1 after the impact with the impactor 11 are acquired.

### <<Step of Calculating a Reference Point-Measurement Point Distance at a Start of Impact>>

A step of calculating a reference point-measurement point distance at a start of impact S11 is to calculate a distance between the measurement point and each of the three reference points at the start of the impact by using the coordinates of the measurement point and the coordinates of the three reference points at the start of the impact which coordinates are acquired in the step of acquiring measurement point coordinates and reference point coordinates at the start of the impact S7.

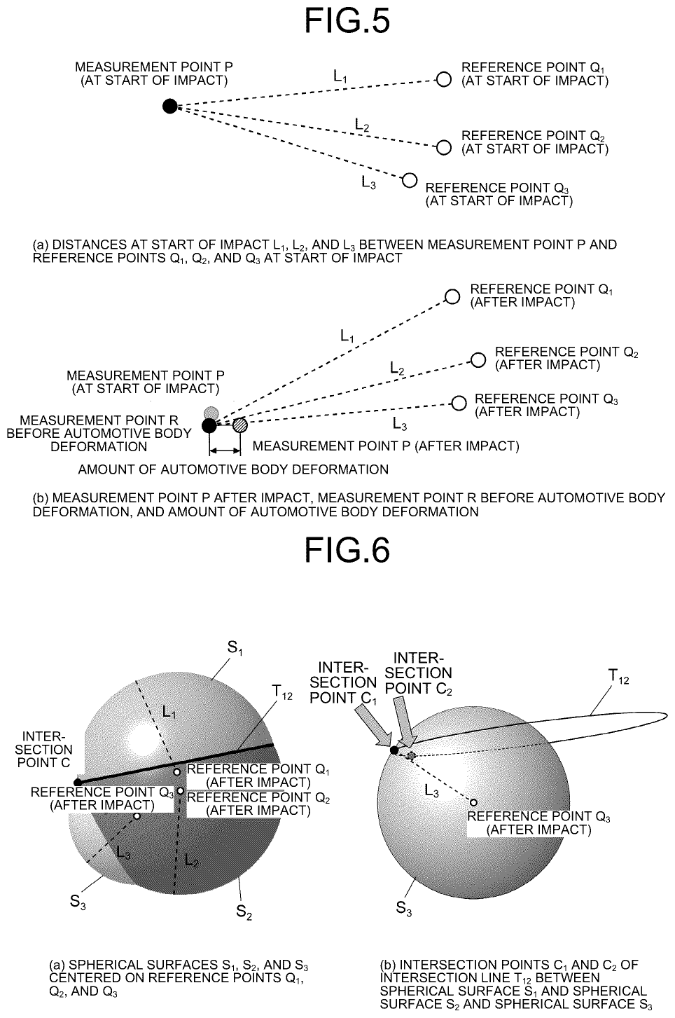

In the first embodiment, as illustrated in FIG. 5(a), by using the coordinates of the measurement point P and the coordinates of the three reference points Q₁, Q₂, and Q₃ in the crashworthiness analysis model 1 at the start of the impact, the distances at the start of the impact L₁, L₂, and L₃ respectively between the reference points Q₁, Q₂, and Q₃ and the measurement point P are calculated.

Furthermore, in the first embodiment, since the eight measurement points P₁ to P₈ are set on the floor panel 5 as described above, the distances at the start of the impact L₁, L₂, and L₃ with the reference points Q₁ to Q₃ are calculated for each of the measurement points P₁ to P₈.

### <<Step of Acquiring Measurement Point Coordinates Before the Automotive Body Deformation>>

The step of acquiring the measurement point coordinates before the automotive body deformation S13 is to acquire coordinates of a position, satisfying the same distance relationship as the distance at the start of the impact from each of the three reference points in the crashworthiness analysis model after the impact, as coordinates of the measurement point before the automotive body deformation in the crashworthiness analysis model after the impact.

In the first embodiment, as illustrated in FIG. 5, coordinates of a measurement point R before the automotive body deformation in the crashworthiness analysis model 1 after the impact are acquired based on the distances at the start of the impact L₁, L₂, and L₃ between the measurement point P and the reference points Q₁, Q₂, and Q₃ at the start of the impact. Furthermore, coordinates of a measurement point R before the automotive body deformation may be acquired by the following procedure as illustrated in FIG. 6 as an example.

First, as illustrated in FIG. 6(a), an intersection line T₁₂ between a spherical surface S₁ centered on the reference point Q₁ at a position after the impact and having the distance at the start of the impact L₁ as a radius and a spherical surface S₂ centered on the reference point Q₂ at the position after the impact and having the distance at the start of the impact L₂ as a radius is acquired.

Subsequently, as illustrated in FIG. 6(a), coordinates of an intersection point C between a spherical surface S₃ centered on the reference point Q₃ at the position after the impact and having the distance at the start of the impact L₃ as a radius and the intersection line T₁₂ are acquired as the coordinates of the measurement point R before the automotive body deformation.

The coordinates of the measurement point R before the automotive body deformation which coordinates are acquired in such a manner correspond to the coordinates of the measurement point P in the crashworthiness analysis model 1 in which the automotive body makes parallel movement or rotational movement by the impact without deformation.

Note that as illustrated in FIG. 6(b), there is a case where two intersection points C₁ and C₂ are present on the spherical surface S₃ and the intersection line T₁₂. In this case, in the two intersection points C₁ and C₂, one intersection point (such as the intersection point C₂) that is obviously not present on the crashworthiness analysis model 1 is excluded, and coordinates of the other intersection point (such as the intersection point C₁) are acquired as the coordinates of the measurement point R before the automotive body deformation.

In addition, in the first embodiment, since the measurement points P₁ to P₈ are set as illustrated in FIG. 3, coordinates of the measurement points R₁ to R₈ before the automotive body deformation are acquired for each of the measurement points P₁ to P₈ in the step of acquiring measurement point coordinates before the automotive body deformation S13.

### <<Step of Measuring an Amount of Automotive Body Deformation>>

The step of measuring an amount of automotive body deformation S15 is to measure an amount of automotive body deformation at the measurement point by using the coordinates of the measurement point before the automotive body deformation and the coordinates of the measurement point after the automotive body deformation which coordinates are acquired for the crashworthiness analysis model after the impact.

In the first embodiment, as illustrated in FIG. 5(b), for the measurement point P (P₁ to P₈), the amount of automotive body deformation at each of the measurement points P₁ to P₈ is measured by utilization of the coordinates of the measurement point R (R₁ to R₈) before the automotive body deformation in the crashworthiness analysis model 1 after the impact which coordinates are acquired in the step of acquiring the measurement point coordinates before the automotive body deformation S13 and the coordinates of the measurement point P (P₁ to P₈) after the automotive body deformation in the crashworthiness analysis model 1 after the impact (FIG. 2(b)) which coordinates are acquired in the step of acquiring the measurement point coordinates and the reference point coordinates after the impact S9.

As described above, according to the method of measuring an amount of automotive body deformation according to the first embodiment, in the crashworthiness analysis using the crashworthiness analysis model of the automobile, the three reference points are provided in the portion where the automotive body deformation is small, and the coordinates of the measurement point before the automotive body deformation in the crashworthiness analysis model after the impact are acquired by utilization of the distance relationship, at the start of the impact, between the three reference points and the measurement point at which the amount of automotive body deformation is measured, whereby the parallel movement amount and the rotational movement amount of the entire crashworthiness analysis model due to the impact can be removed, and the amount of automotive body deformation at the measurement point can be measured. As a result, since the amount of automotive body deformation due to the impact can be accurately acquired, an automotive body deformation phenomenon due to the impact can be understood, and improvement in the crash worthiness and weight reduction of the automotive body become possible.

### <Program of Measuring an Amount of Automotive Body Deformation>

Note that the method of measuring the amount of automotive body deformation of the first embodiment can be configured as a program of measuring an amount of automotive body deformation in a crashworthiness analysis of an automobile which program causes a computer to measure the amount of automotive body deformation of the automobile deformed due to impact in the crashworthiness analysis of the automobile (hereinafter, “program of measuring an amount of automotive body deformation”).

The program of measuring the amount of automotive body deformation according to the first embodiment is to cause the computer to measure the amount of automotive body deformation of the automobile deformed by the impact in the crashworthiness analysis of the automobile, and causes the computer to execute a crashworthiness analysis model acquisition step of acquiring a crashworthiness analysis model of the automobile, a crashworthiness analysis step of performing the crashworthiness analysis of the crashworthiness analysis model, a step of setting a measurement point of an amount of automotive body deformation and reference points in which step the measurement point at which the amount of automotive body deformation in the crashworthiness analysis model is measured and three reference points in a portion with no or little deformation of the automotive body in the crashworthiness analysis model are set, a step of acquiring measurement point coordinates and reference point coordinates at the start of the impact in which step coordinates of the measurement point and coordinates of the three reference points in the crashworthiness analysis model at the start of the impact are acquired, a step of acquiring the measurement point coordinates and the reference point coordinates after the impact in which step the coordinates of the measurement point and the coordinates of the three reference points after the impact are acquired for the crashworthiness analysis model after the impact after a lapse of a predetermined time from the start of the impact based on a result of the crashworthiness analysis, a step of calculating a reference point-measurement point distance at the start of the impact in which step a distance to the measurement point at the start of the impact is calculated for each of the three reference points by utilization of the coordinates of the measurement point and the coordinates of the three reference points in the crashworthiness analysis model at the start of the impact, a step of acquiring measurement point coordinates before the automotive body deformation in which step coordinates of a position that satisfies the same distance relationship as the distance from each of the three reference points at the start of the impact in the crashworthiness analysis model after the impact are acquired as the coordinates of the measurement point before the automotive body deformation in the crashworthiness analysis model after the impact, and a step of measuring an amount of automotive body deformation in which step the amount of the automotive body deformation at the measurement point is measured by utilization of the coordinates of the measurement point before the automotive body deformation and the coordinates of the measurement point after the impact which coordinates are acquired for the crashworthiness analysis model after the impact.

As illustrated in FIG. 1, the program of measuring the amount of automotive body deformation according to the first embodiment causes the computer to execute steps S1 to S15, whereby an effect similar to that of the method of measuring the amount of automotive body deformation according to the first embodiment described above can be acquired.

### Second Embodiment

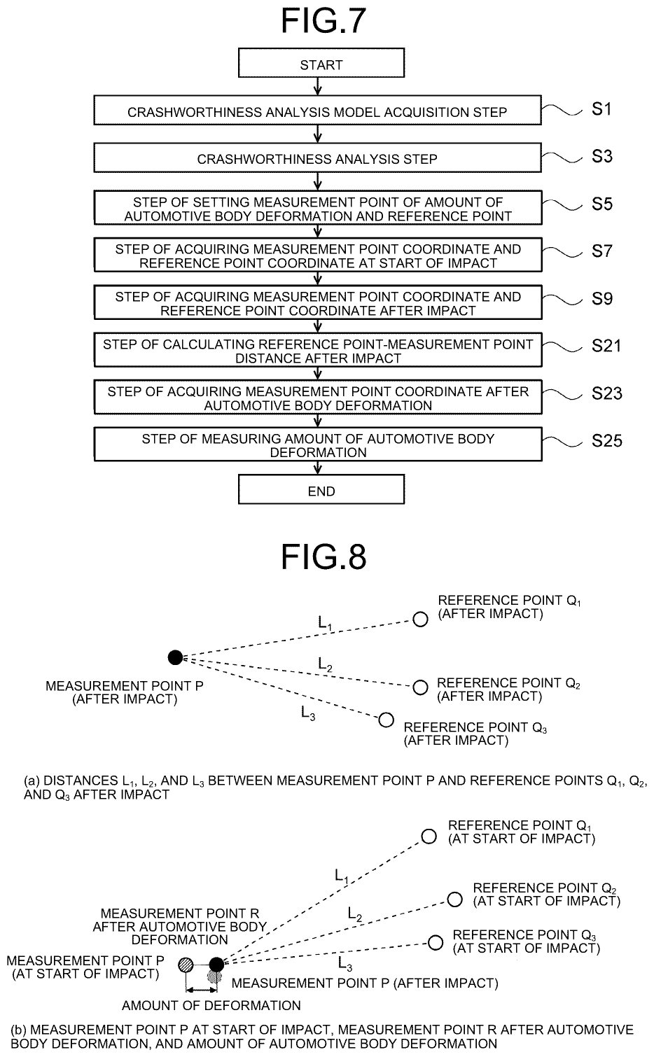

A method of measuring an amount of automotive body deformation in a crashworthiness analysis of an automobile according to the second embodiment of the present invention is to measure the amount of automotive body deformation of the automobile deformed by impact in the crashworthiness analysis of the automobile, and includes, as illustrated in FIG. 7, a crashworthiness analysis model acquisition step S1, a crashworthiness analysis step S3, a step of setting a measurement point of an amount of automotive body deformation and a reference point S5, a step of acquiring measurement point coordinates and reference point coordinates at a start of impact S7, a step of acquiring measurement point coordinates and reference point coordinates after the impact S9, a step of calculating a reference point-measurement point distance after the impact S21, a step of acquiring measurement point coordinates after automotive body deformation S23, and a step of measuring the amount of automotive body deformation S25, the steps being performed by a computer.

Here, since the crashworthiness analysis model acquisition step S1, the crashworthiness analysis step S3, the step of setting a measurement point of an amount of automotive body deformation and a reference point S5, the step of acquiring measurement point coordinates and reference point coordinates at a start of impact S7, the step of acquiring measurement point coordinates and reference point coordinates after the impact S9 are the same as those in the first embodiment described above, the step of calculating a reference point-measurement point distance after the impact S21, the step of acquiring measurement point coordinates after automotive body deformation S23, and the step of measuring the amount of automotive body deformation S25 will be described in the following.

<<Step of Calculating a Reference Point-Measurement Point Distance after Impact>>

The step of calculating a reference point-measurement point distance after the impact S21 is to calculate a post-impact distance between each of three reference points and a measurement point by using coordinates of the measurement point and coordinates of the three reference points in a crashworthiness analysis model after impact which coordinates are acquired in the step of acquiring measurement point coordinates and reference point coordinates after the impact S9.

In the second embodiment, as illustrated in FIG. 8(a), by utilization of coordinates of a measurement point P and coordinates of three reference points Q₁, Q₂, and Q₃ in a crashworthiness analysis model 1 after impact after a lapse of a predetermined time from a start of the impact, post-impact distances L₁, L₂, and L₃ between the respective reference points Q₁, Q₂, and Q₃ and the measurement point P are calculated.

Furthermore, in the second embodiment, similarly to the first embodiment described above, since eight measurement points P₁ to P₈ are set on a floor panel 5 (see FIG. 3), the post-impact distances L₁, L₂, and L₃ to the reference points Q₁ to Q₃ are calculated for each of the measurement points P₁ to P₈.

<<Step of Acquiring Measurement Point Coordinates after Automotive Body Deformation>>

In the step of acquiring measurement point coordinates after automotive body deformation S23, coordinates of a position satisfying the same distance relationship as a post-impact distance from each of the three reference points in the crashworthiness analysis model at the start of the impact are acquired as coordinates of the measurement point after the automotive body deformation in the crashworthiness analysis model at the start of the impact.

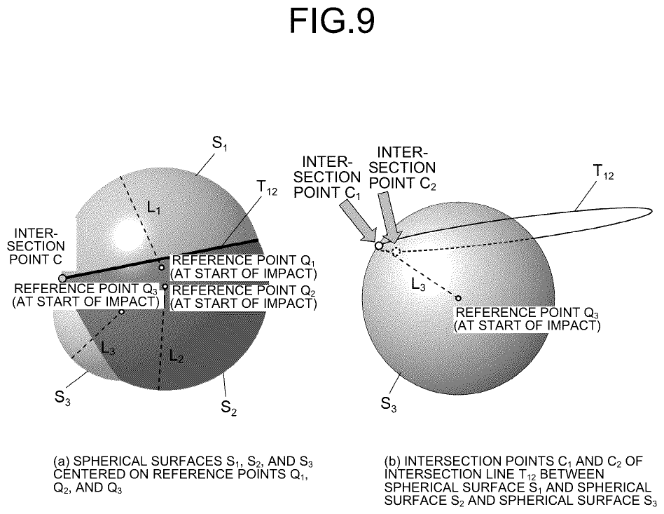

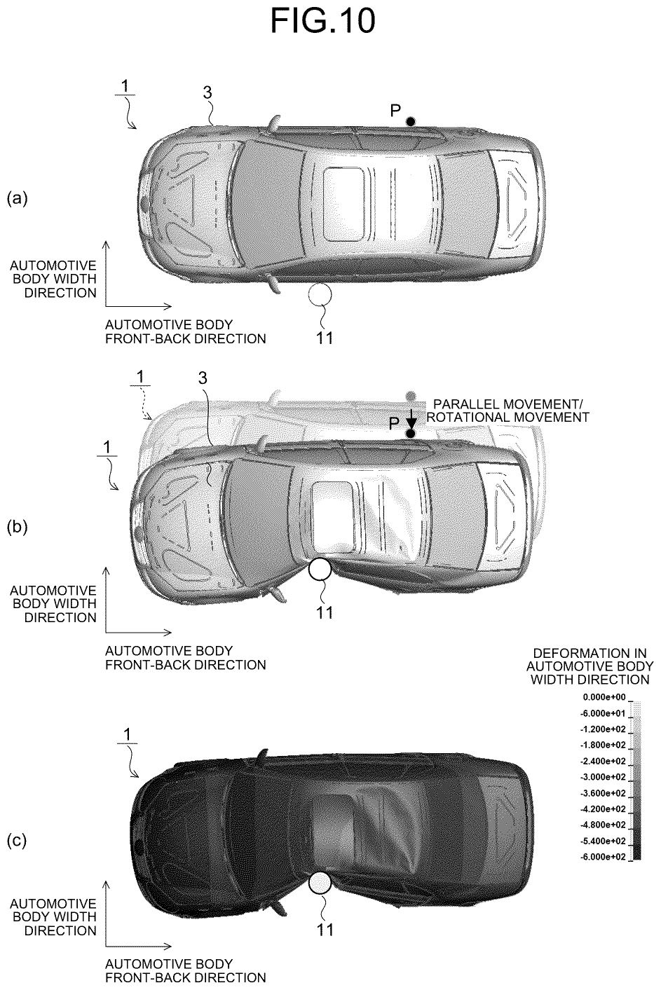

In the second embodiment, as illustrated in FIG. 8, coordinates of a measurement point R after the automotive body deformation in the crashworthiness analysis model 1 at the start of the impact are acquired based on the post-impact distances L₁, L₂, and L₃ between the measurement point P and the reference points Q₁, Q₂, and Q₃ after the impact. Furthermore, coordinates of the measurement point R after the automotive body deformation may be acquired by the following procedure as illustrated in FIG. 9 as an example.

First, as illustrated in FIG. 9(a), an intersection line T₁₂ between a spherical surface S₁ centered on the reference point Q₁ at a position at the start of impact and having the post-impact distance L₁ as a radius and a spherical surface S₂ centered on the reference point Q₂ at a position at the start of the impact and having the post-impact distance L₂ as a radius is acquired.

Subsequently, as illustrated in FIG. 9(b), coordinates of an intersection point C between a spherical surface S₃ centered on the reference point Q₃ at a position at the start of the impact and having the post-impact distance L₃ as a radius and the intersection line T₁₂ are acquired as the coordinates of the measurement point R before the automotive body deformation.

The coordinates of the measurement point R after the automotive body deformation which coordinates are acquired in such a manner correspond to the coordinates of the measurement point P in the crashworthiness analysis model 1 in which the automotive body is deformed by the impact without parallel movement or rotational movement.

Note that as illustrated in FIG. 9(b), there is a case where two intersection points C₁ and C₂ are present on the spherical surface S1 and the intersection line T₁₂. In this case, in the two intersection points C₁ and C₂, one intersection point (such as the intersection point C₂) that is obviously not present on the crashworthiness analysis model 1 is excluded, and coordinates of the other intersection point C₁ are acquired as the coordinates of the measurement point R after the automotive body deformation.

In addition, in the second embodiment, since the measurement points P₁ to P₈ are set as illustrated in FIG. 3, in the step of acquiring measurement point coordinates before the automotive body deformation S13, coordinates of measurement points R₁ to R₈ before the automotive body deformation are acquired for each of the measurement points P₁ to P₈.

### <<Step of Measuring an Amount of Automotive Body Deformation>>

The step of measuring an amount of automotive body deformation S25 is to measure the amount of automotive body deformation at the measurement point by using the coordinates of the measurement point after the automotive body deformation and the coordinates of the measurement point at the start of the impact which coordinates are acquired for the crashworthiness analysis model at the start of the impact.

In the second embodiment, as illustrated in FIG. 8(b), for the measurement point P (P₁ to P₈), the amount of automotive body deformation at each of the measurement points P₁ to P₈ is measured by utilization of the coordinates of the measurement point R (R₁ to R₈) after the automotive body deformation in the crashworthiness analysis model 1 at the start of the impact which coordinates are acquired in the step of acquiring the measurement point coordinates after the automotive body deformation S23 and the coordinates of the measurement point P (P₁ to P₈) before the automotive body deformation in the crashworthiness analysis model 1 at the start of the impact (FIG. 2(a)) which coordinates are acquired in the step of acquiring the measurement point coordinates and the reference point coordinates at the start of the impact S7.

As described above, according to the method of measuring the amount of automotive body deformation according to the second embodiment, similarly to the method of measuring the amount of automotive body deformation according to the first embodiment described above, the three reference points are provided in the portion where the deformation amount of the automotive body is small, and the parallel movement amount and the rotational movement amount of the entire crashworthiness analysis model due to the impact are removed by utilization of the distance relationship between the three reference points and the measurement point at which the amount of automotive body deformation is measured, whereby the amount of automotive body deformation can be measured. As a result, an automotive body deformation phenomenon due to the impact can be understood, and improvement in the crash worthiness and weight reduction of the automotive body become possible.

Furthermore, in the method of measuring the amount of automotive body deformation according to the second embodiment, the post-impact distance between the measurement point and the three reference points after the deformation by the impact is calculated. The post-impact distance has an absolute value smaller than the distance at the start of the impact in the first embodiment described above.

Thus, according to the method of measuring the amount of automotive body deformation according to the second embodiment, since an error in the coordinates of the measurement point after the automotive body deformation which measurement point satisfies the same distance relationship as the post-impact distance is small, the amount of automotive body deformation can be measured with high accuracy as compared with the first embodiment.

### <Program of Measuring an Amount of Automotive Body Deformation>

Note that the method of measuring the amount of automotive body deformation of the second embodiment can be configured as a program of measuring an amount of automotive body deformation in a crashworthiness analysis of an automobile which program causes a computer to measure the amount of automotive body deformation of the automobile deformed due to the impact in the crashworthiness analysis of the automobile.

The program of measuring the amount of automotive body deformation according to the second embodiment is to cause the computer to measure the amount of automotive body deformation of the automobile deformed by the impact in the crashworthiness analysis of the automobile, and causes the computer to execute a crashworthiness analysis model acquisition step of acquiring a crashworthiness analysis model of the automobile, a crashworthiness analysis step of performing the crashworthiness analysis of the crashworthiness analysis model, a step of setting a measurement point of an amount of automotive body deformation and reference points in which step the measurement point at which the amount of automotive body deformation in the crashworthiness analysis model is measured and three reference points in a portion with no or little deformation of the automotive body in the crashworthiness analysis model are set, a step of acquiring measurement point coordinates and reference point coordinates at a start of the impact in which step coordinates of the measurement point and coordinates of the three reference points in the crashworthiness analysis model at the start of the impact are acquired, a step of acquiring measurement point coordinates and reference point coordinates after the impact in which step the coordinates of the measurement point and the coordinates of the three reference points after the impact are acquired with respect to the crashworthiness analysis model after the impact after a lapse of a predetermined time from the start of the impact based on a result of the crashworthiness analysis, a step of calculating a reference point-measurement point distance after the impact in which step a post-impact distance to the measurement point is calculated for each of the three reference points by utilization of the coordinates of the measurement point and the coordinates of the three reference points in the crashworthiness analysis model after the impact, a step of acquiring measurement point coordinates after the automotive body deformation in which step coordinates of a position that satisfies the same distance relationship as the post-impact distance from each of the three reference points in the crashworthiness analysis model at the start of the impact are acquired as the coordinates of the measurement point after the automotive body deformation by the impact in the crashworthiness analysis model at the start of the impact, and a step of measuring an amount of automotive body deformation in which step the amount of automotive body deformation at the measurement point is measured by utilization of the coordinates of the measurement point after the automotive body deformation and the coordinates of the measurement point at the start of the impact which coordinates are acquired for the crashworthiness analysis model at the start of the impact.

As illustrated in FIG. 7, in the program of measuring the amount of automotive body deformation according to the second embodiment, by execution of the step S1 to step S25, an effect similar to that of the method of measuring the amount of automotive body deformation according to the second embodiment described above can be acquired.

### Examples

Since an analysis to confirm the effect of the present invention has been performed, a description thereof will be made in the following. In the present example, as illustrated in FIG. 2, an amount of automotive body deformation was measured according to the procedure described in the second embodiment described above for a side impact in which the impactor 11 impacts on a left side surface of the crashworthiness analysis model 1 in the automotive body width direction.

In measurement of the amount of automotive body deformation, first, as illustrated in FIG. 3, the measurement points P₁ to P₈ at which the amount of automotive body deformation was measured were set on the floor panel 5 included in the automotive body 3 of the crashworthiness analysis model 1. Here, the measurement points P₁ to P₃ were set at positions in the vicinity of a B pillar on the floor panel 5, the measurement points P₄ to P₇ were set at positions a seat attachment hole in the floor panel 5, and P₈ was set at a position at the center of the seat attachment hole.

In addition, as illustrated in FIG. 4, the reference points Q₁ to Q₃ were set on a right side surface portion 3a where the deformation of the automotive body is small in the side impact of the crashworthiness analysis model 1.

Then, crashworthiness analysis conditions such as a position, a direction, and an impact speed (=29 km/h) at which the impactor 11 impacts on the crashworthiness analysis model 1 were set, and the crashworthiness analysis was performed.

Subsequently, based on a result of the crashworthiness analysis, coordinates of the measurement points P₁ to P₈ and coordinates of the reference points Q₁ to Q₃ at a start of impact, and the coordinates of the measurement points P₁ to P₈ and the coordinates of the reference points Q₁ to Q₃ after the impact after a lapse of 0.05 sec from the start of the impact were acquired.

Subsequently, for each of the measurement points P₁ to P₈ on the floor panel 5 of the crashworthiness analysis model 1 after the impact, post-impact distances to the reference points Q₁ to Q₃ were calculated, and coordinates of the measurement point R after the automotive body deformation in the crashworthiness analysis model 1 at the start of impact were acquired as illustrated in FIG. 8.

Then, the amount of automotive body deformation was measured from the coordinates of the measurement point after the automotive body deformation and the coordinates of the measurement point at the start of the impact. In the present example, as the amount of automotive body deformation, the sum of the amount of automotive body deformation in a front-back direction of the automotive body (X direction), an automotive body width direction (Y direction), and an automotive body vertical direction (Z direction), and the amount of automotive body deformation in the automotive body width direction (Y direction) were measured.

The coordinates of the reference points Q₁ to Q₃ set in the crashworthiness analysis model 1 at the start of the impact and after the impact after a lapse of 0.05 sec from the start of the impact are illustrated in Table 1.

TABLE 1

| | | | | Coordinate after impact | | |
|---|---|---|---|---|---|---|
| Reference | Coordinate at start of impact | | | (after 0.05 sec) | | |
| point | x/mm | y/mm | z/mm | x/mm | y/mm | z/mm |
| Q₁ | 1731.54 | 791.2 | 47.62 | 1735.81 | 1022.62 | 61.93 |
| Q₂ | 1415.08 | 791.2 | −16.69 | 1419.11 | 1010.39 | −0.31 |
| Q₃ | 1074.82 | 791.2 | 47.62 | 1079.76 | 990.005 | 65.97 |

Furthermore, for each of the measurement points P₁ to P₈ set on the floor panel 5, the coordinates at the start of the impact and the coordinates after the impact after the lapse of 0.05 sec from the start of the impact, coordinates of the intersection point C₁ and the intersection point C₂ of the three spherical surfaces S₁ to S₃ having, as radii, the post-impact distances L₁ to L₃ to the three reference points Q₁ to Q₃ after the impact as illustrated in FIG. 9, and a result of the amount of automotive body deformation at each of the measurement points P₁ to P₈ are illustrated in Table 2.

TABLE 2

| | | | | | | | Movement amount of [after | | |
|---|---|---|---|---|---|---|---|---|---|
| | | | | | | | impact − at start of impact] | | |
| | | | | | | | (including parallel movement | | |
| Measurement | At start of impact (0 sec) | | | After impact (0.05 sec) | | | and rotational movement) | | |
| point | X/mm | Y/mm | Z/mm | X/mm | Y/mm | Z/mm | X/mm | Y/mm | Z/mm |
| P₁ | 1379.35 | −656.427 | 18.0817 | 1459.26 | −432.62 | −25.0973 | 79.91 | 223.807 | −43.179 |
| P₂ | 1466.23 | −654.523 | −5.55282 | 1547.49 | −425.818 | −42.787 | 81.26 | 228.705 | −37.23418 |
| P₃ | 1552.26 | −655.448 | −9.18098 | 1634 | −420.888 | −45.6291 | 81.74 | 234.560 | −36.4393 |
| P₄ | 866.334 | −142.685 | 118.843 | 919.424 | 47.2564 | 94.58 | 53.09 | 189.9414 | −24.263 |
| P₅ | 1423.8 | −139.549 | 24.8178 | 1475.79 | 83.2486 | −1.9489 | 52.79 | 222.7976 | −26.7667 |
| P₆ | 881.726 | −567.706 | 97.5166 | 957.083 | −370.475 | 49.2849 | 75.357 | 197.231 | −48.2317 |
| P₇ | 1423.74 | −567.46 | 15.4916 | 1499.66 | −342.453 | −18.9543 | 75.92 | 225.007 | −34.4459 |
| P₈ | 1146.8 | −356.758 | 70.0599 | 1210.70 | −149.466 | 37.1156 | 63.90 | 207.292 | −32.9443 |

| | | | | | | | Amount of automotive | |
|---|---|---|---|---|---|---|---|---|
| Measurement | Intersection point C₁ | | | Intersection point C₂ | | | body deformation | |
| point | X/mm | Y/mm | Z/mm | X/mm | Y/mm | Z/mm | XYZ/mm | Y/mm |
| P₁ | 1383.688 | 2233.648 | 36.802 | 1383.688 | −651.248 | 36.802 | 19.9 | 5.2 |
| P₂ | 1472.274 | 2232.17 | 19.544 | 1472.274 | −649.77 | 19.544 | 26.2 | 4.8 |
| P₃ | 1558.959 | 2231.665 | 17.205 | 1558.959 | −649.265 | 17.205 | 27.9 | 6.2 |
| P₄ | 867.498 | 1721.929 | 125.485 | 867.498 | −139.529 | 125.485 | 7.4 | 3.2 |
| P₅ | 1425.678 | 1718.732 | 32.083 | 1425.678 | −136.332 | 32.083 | 8.2 | 3.2 |
| P₆ | 884.653 | 2142.857 | 103.252 | 884.653 | −560.457 | 103.252 | 9.7 | 7.2 |
| P₇ | 1428.487 | 2145.381 | 38.386 | 1428.487 | −562.981 | 38.386 | 23.8 | 4.5 |
| P8 | 1149.061 | 1935.63 | 81.36 | 1149.061 | −353.23 | 81.36 | 12.1 | 3.5 |

From the results of Table 2, it is obvious that, in the intersection point C₁ and the intersection point C₂, the intersection point C₂ is a point that is not located on the crashworthiness analysis model 1 since Y coordinates of the intersection point C₂ are all minus (−) and substantially the same as those at the start of the impact. Thus, the intersection point C₁ is specified as the measurement point R after the automotive body deformation in the crashworthiness analysis model 1 at the start of the impact.

Furthermore, as illustrated in Table 2, parallel movement and rotational movement of the crashworthiness analysis model 1 due to the impact were removed from the automotive body deformation amount at the measurement points P₁ to P₈, and it became obvious that the amount of automotive body deformation is on the order of 10 mm or less in both the total deformation in the XYZ directions and the deformation in the automotive body width direction.

### INDUSTRIAL APPLICABILITY

According to the present invention, in a crashworthiness analysis using a crashworthiness analysis model of an automobile, it is possible to provide a method of measuring an amount of automotive body deformation and a program of measuring the amount of automotive body deformation in the crashworthiness analysis of the automobile with which method and program the amount of automotive body deformation from which a movement amount due to parallel movement or rotational movement by an impact of the crashworthiness analysis model is removed can be measured.

### REFERENCE SIGNS LIST

1 CRASHWORTHINESS ANALYSIS MODEL
3 AUTOMOTIVE BODY
3a RIGHT SIDE SURFACE PORTION
5 FLOOR PANEL
11 IMPACTOR
C, C₁, and C₂ INTERSECTION POINT
P, P₁, P₂, P₃, P₄, P₅, P₆, P₇, and P₈ MEASUREMENT POINT
Q, Q₁, Q₂, and Q₃ REFERENCE POINT
S₁, S₂, and S₃ SPHERICAL SURFACE
T₁₂ INTERSECTION LINE

1-4. (canceled)

5. A method of measuring an amount of automotive body deformation in a crashworthiness analysis, the method comprising:
acquiring a crashworthiness analysis model of an automobile deformed by impact;
performing the crashworthiness analysis of the crashworthiness analysis model;
setting a measurement point where the amount of automotive body deformation in the crashworthiness analysis model is measured;
setting three reference points in a portion with no or little deformation of the automotive body in the crashworthiness analysis model;
acquiring coordinates of the measurement point and coordinates of the three reference points in the crashworthiness analysis model at a start of the impact;
acquiring the coordinates of the measurement point and the coordinates of the three reference points after the impact for the crashworthiness analysis model after the impact after a lapse of a predetermined time from the start of the impact based on a result of the crashworthiness analysis;
calculating a distance at the start of the impact between each of the three reference points and the measurement point by using the coordinates of the measurement point and the coordinates of the three reference points in the crashworthiness analysis model at the start of the impact;
acquiring coordinates of a position that satisfies a same distance relationship as the distance at the start of the impact from each of the three reference points in the crashworthiness analysis model after the impact as the coordinates of the measurement point before the automotive body deformation in the crashworthiness analysis model after the impact; and
measuring the amount of the automotive body deformation at the measurement point by using the coordinates of the measurement point before the automotive body deformation acquired for the crashworthiness analysis model after the impact and the coordinates of the measurement point after the impact.

6. A method of measuring an amount of automotive body deformation in a crashworthiness analysis, the method comprising:
acquiring a crashworthiness analysis model of an automobile deformed by impact;
performing the crashworthiness analysis of the crashworthiness analysis model;
setting a measurement point where the amount of automotive body deformation in the crashworthiness analysis model is measured;
setting three reference points in a portion with no or little deformation of the automotive body in the crashworthiness analysis model;
acquiring coordinates of the measurement point and coordinates of the three reference points in the crashworthiness analysis model at a start of the impact;
acquiring the coordinates of the measurement point and the coordinates of the three reference points after the impact for the crashworthiness analysis model after the impact after a lapse of a predetermined time from the start of the impact based on a result of the crashworthiness analysis;
calculating a post-impact distance between each of the three reference points and the measurement point by using the coordinates of the measurement point and the coordinates of the three reference points in the crashworthiness analysis model after the impact;
acquiring coordinates of a position that satisfies a same distance relationship as the post-impact distance from each of the three reference points in the crashworthiness analysis model at the start of the impact as the coordinates of the measurement point after the automotive body deformation by the impact in the crashworthiness analysis model at the start of the impact; and
measuring the amount of the automotive body deformation at the measurement point by using the coordinates of the measurement point after the automotive body deformation acquired for the crashworthiness analysis model at the start of the impact and the coordinates of the measurement point at the start of the impact.

7. A non-transitory computer-readable recording medium on which an executable program for measuring an amount of automotive body deformation in a crashworthiness analysis is recorded, the program causing a processor of a computer to execute the method according to claim 5.

8. A non-transitory computer-readable recording medium on which an executable program for measuring an amount of automotive body deformation in a crashworthiness analysis is recorded, the program causing a processor of a computer to execute the method according to claim 6.
